(19) United States
(12) Patent Application Publication
(10) Pub. No.: US 2007/0288982 A1
(43) Pub. Date: Dec. 13, 2007

(54) Dynamic ingress arrester

(75) Inventor: John Donahue, North East, MD (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 11/452,151

(22) Filed: Jun. 13, 2006

(51) Int. Cl. H04N 7/173

(52) U.S. Cl. 725/125; 725/124

(57) ABSTRACT

A method, system, and apparatus for combating ingress influences on network communications. The method, system, and apparatus may be suitable for use in any number of network environments and for identifying, minimizing, or otherwise ameliorating the influence of ingress on network communications.

### BACKGROUND OF THE INVENTION

1. Field of the Invention

The present invention relates to networking systems and identifying sources of ingress within such systems.

2. Background Art

Ingress generally relates to noise or other interferences influencing electronic signal communications, such as but not limited to leakage from unwanted stray signals and radio frequency interferences. Ingress is a common problem in networking systems where wireline communications transmit signals between different locations, such as cable television, high speed data, and other wireline systems. Ingress can corrupt or degrade signal integrity and disrupt communications.

One typical ingress problem relates to hybrid fiber coaxial (HFC) networking systems commonly employed in cable television networks. As one skilled in the art will appreciate, ingress can arise from any number of sources associated with networking systems. Typically, ingress tends to occur within upstream communication paths where multiple customer premise devices aggregate communications over a common communication medium.

This can be problematic in some environments as ingress from one location can influence signal quality of signals from other locations, especially when the signals are subsequently combined and carried over a common distribution leg. Identifying the ingress source or otherwise narrowing down its location can be paramount to improving signal quality and particularly difficult if the signals are received from multiple distribution legs before combining into the common distribution leg.

### SUMMARY OF THE INVENTION

Accordingly, one non-limiting and optional aspect of the present invention relates to dynamic ingress arrester (DIA) configured to facilitate identifying ingress sources and/or distribution legs having ingress.

Another non-limiting and optional aspect of the present invention relates to identifying sources of ingress and limiting the ingress influence on other signal communications.

Another non-limiting and optional aspect of the present invention relates to attenuating signals and/or distribution legs associated with undesirable ingress so as to arrested or otherwise limit continued transmission of the ingress overly influencing other signal communications.

Another non-limiting and optional aspect of the present invention relates to automatically attenuating ingress without requiring operator intervention, and optionally, thereafter notifying the operator of the associated ingress source.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a networking system in accordance with one non-limiting aspect of the present invention; and

FIG. 2 illustrates a flowchart of a method of identifying ingress sources in accordance with one non-limiting aspect of the present invention.

### DETAILED DESCRIPTION OF THE PREFERRED EMBODIMENT(S)

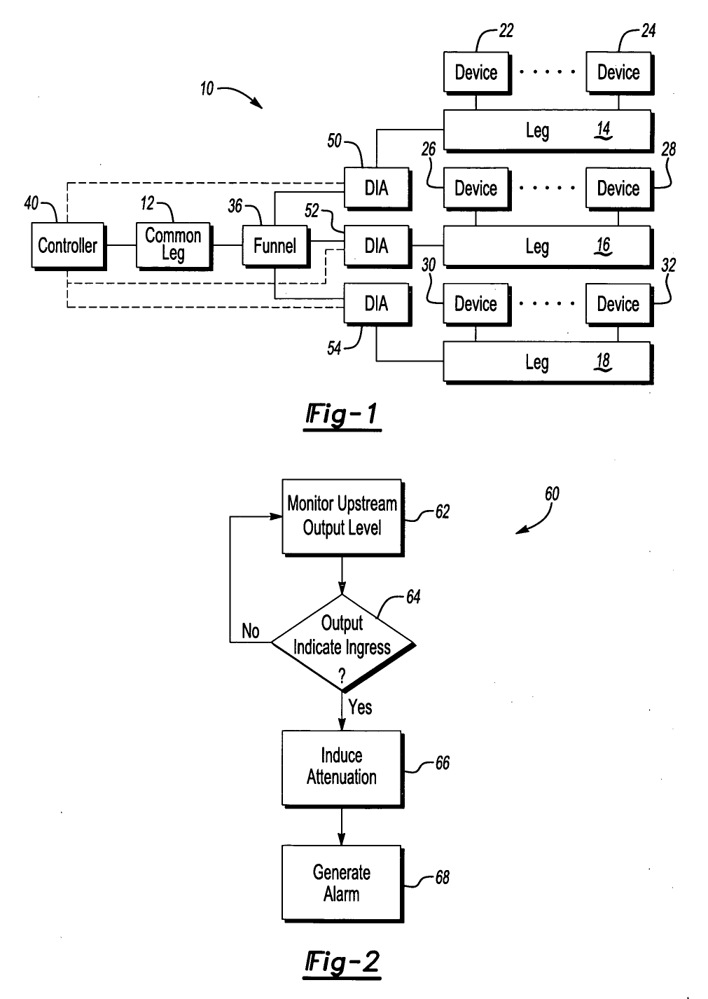

FIG. 1 illustrates a networking system 10 in accordance with one non-limiting aspect of the present invention. The system 10 includes a number of distribution legs 12-18 for communicating signals between different locations. For exemplary purposes, the distribution legs 12-18 communicate signals between any number of network devices 22-32 and a funnel 36, which then combines the signals for transport over a common distribution leg 12 to a controller 40 or other entity. This arrangement may be used in any number environments to aggregate signals from any number of network devices 22-32, such as but not limited to cable television, satellite television, wireline and wireless area networks, private and virtual private networks, and the like. As such, the present invention is not intended to be limited to any particular environment and fully contemplates its use in any number of environments.

The network devices 22-32 may relate to any type of network device having capabilities for upstream signal communications, i.e., the communication of signals in a direction from their location towards the controller 40, such as but not limited to a standalone and/or integrated device, like a cable modem (CM), personal digital assistant (PDA), mobile device (phone, computer, music/video player, etc.), outlet digital adapters (ODAs), media terminal adapter (MTA), converter, computer, settop box (STB), digital video recorder (DVR), headend, router, hub, switch, gateway, conditional access router (CAR), home gateway, cable modem termination system (CMTS), network provisioning unit (NPU), session boarder controller, media gateway, media gateway controller, signaling gateway, call management server, presence server, SIP routing proxy, SIP proxy/registrar server, PCMM policy server, bandwidth on demand server, streaming server caching proxy, gaming server, CDN, media acquisition server, provider server, unified messaging server, OSS/BSS, global directory server, personal video recorder (PVR), and/or any other item having capabilities to support access to any number of services, and other elements not associated with so called services, such as but not limited to back office servers and other network related elements.

The network devices 22-32 may be configured to descramble and support and/or facilitate the use of any number of television and non-television related signals, such as but not limited to. Hyper Text Transfer Protocol (HTTP), Dynamic Host Configuration Protocol (DHCP), Syslog, Simple Network Management Protocol (SNMP), Trivial File Transfer Protocol (TFTP), Data Over Cable Service Interface Specification (DOCSIS), Domain Name Server (DNS) applications, DOCSIS Settop Gateway (DSG), out-of-band (OOB) messaging, and others.

Of course, the present invention is not intended to be limited to the foregoing and fully contemplates the network devices 22-32 being associated with any number of other customer and non-customer premise equipment requiring data communications, and not just those listed above or associated with cable television applications and services.

The distribution legs 12-18 may relate to any wireline or wireless, terrestrial or extraterrestrial arrangement suitable for communicating electronic signals to and from the network devices 22-32. One or more of the distribution legs 12-18 may include configurations that differ from the other distribution legs 12-18. For example, and without intending to limit the scope and contemplation of the present invention, the individual distribution legs 14-18 may be cable lines or other wire/fiber optic lines, wireless arrangements and the common distribution leg 12 may be a fiber optic line or other high or ultra high speed medium having more advanced capabilities than the individual distribution legs 14-18 or other so called ‘last mile’ arrangements. Of course, the present invention is not so limited and fully contemplates the distribution legs include the same or similar configurations and capabilities.

The controller 40 may relate to any device, entity, or element associated with the network devices 22-32, including those elements listed above with respect to the network devices 22-32, such as but not limited to network devices 22-32 that support operations or otherwise interact with other network devices 22-32. For example, the controller 40 may be a router configured to route signals received from cable modems or other network devices to remote networks. The controller 40 is differentiated from the other network devices 22-32 for exemplary purposes and to illustrate its positioning at a location upstream from the funnel 36 so as to demonstrate one ingress situation addressed by the present invention wherein an entity receives signals aggregated from a number of sources.

In particular, and without intending to limit the scope and contemplation of the present invention, the exemplary configuration shown in FIG. 1 illustrates an environment where ingress from any number of network devices 22-32 may influence signal quality of other network devices 22-32. As shown, multiple distribution legs 14-18 are funneled into the common distribution leg 14 such that ingress from any one of the distribution legs 14-18 or network devices can influence other signals carried over the common distribution leg 12.

As noted above, the network devices 22-32 may relate to any number of elements, components, or other enterprises having capabilities to support network communications and/or other network related operations. The network devices 22-32 may relate to customer premises devices/equipment and/or intermediary elements associated with supporting services interfaced with the customer and non-customer related devices. Accordingly, the present invention contemplates any number configurations and capabilities for the network devices 22-32 and controller 40 and is not intended to be limited to any particular arrangement of the same or to those specified above.

The system 10 may include one or more dynamic ingress arresters (DIAs) 50-54 to facilitate identifying sources of ingress and/or limiting the influence of the same. The DIAs 50-54 may be configured to monitor, sample, measure, and otherwise diagnose signaling carried over the distribution legs 12-18 and to process such information for use in assessing ingress and other noise distortion that may be influencing signal quality. The DIAs 50-54 may be any suitable configured apparatus or element having capabilities sufficient to execute operations contemplated by the present invention for facilitating ingress source identification.

Optionally, the DIAs 50-54 may include a memory, processor, and other electronic circuits or devices with appropriate components for detection of RF energy within a defined spectrum, such as to facilitate voltage/power level detection and threshold analysis. The DIAs 50-54 may contain solid-state, surface mounted and/or discrete components within a self-contained housing designed for use in hybrid fiber coaxial (HFC) plants in outside environments or other environments, such as but limited to all fiber systems. It may be sized in a manner similar to directional couplers or line splitters commonly use in HFC systems.

Of course, the present invention contemplates any number of configurations for the DIAs 50-54 and is not intended to be limited to the foregoing. In particular, the DIAs 50-54 need not necessarily be standalone, after market features, connected to the distribution legs. Rather, the DIAs 50-54 may be integrated with one or more of the devices connected to the legs and/or the DIAs 50-54 may be applications or software programs embedded on one of the other distribution leg components or support components having suitable capabilities for executing the operations contemplated by the present invention.

Optionally, the DIAs 50-54 may include capabilities for communicating signals with the controller 40 or other element in the system 10, as shown with the dashed lines. The communication may occur over the common distribution leg 12 or one of the individual distribution legs 14-18, and/or over separate communication mediums, such as to combat situations in which severe ingress prevents communication with the controller 40 or other entities of the common distribution leg.

FIG. 2 illustrates a flowchart 60 of a method of identifying ingress sources in accordance with one non-limiting aspect of the present invention. The method may be carried out by the DIAs 50-54 in accordance with instructions/programming embedded thereon. For exemplary purposes only, the method of the present invention is demonstrated with respect to upstream communications in the system 10 illustrated with FIG. 1. The present invention fully contemplates identifying ingress in any number of wireline and wireless environments and is not intended to be limited to the foregoing or upstream communications.

Block 62 relates to monitoring upstream output levels of one or more of the distribution legs 12-18. As shown in FIG. 1, separate DIAs 50-54 may be deployed to each distribution leg 14-18 for this purpose and configured to monitor output levels for any one or more frequency spectrums associated with the corresponding distribution leg 14-18, such as but not limited to by monitoring voltage or power levels. As one skilled in the art will appreciate, depending on the signals carried over the distribution legs 14-18, in both the upstream and downstream directions, various frequency spectrums may be of interest in assessing ingress, i.e., downstream signals may be less important as the sources of ingress in such signals are limited, upstream signals corresponding with frequencies of reliable sources may be of less interest as the sources are unlikely to induce ingress, but frequencies of unreliable sources, like cable modems, STBs, etc., may be of more interest as these source tend to induce ingress. In this manner, the output levels may be determined for all signals carried within a define frequency spectrum of the distribution legs and/or for specific or individual signals carried within the distribution leg.

Block 64 relates to assessing whether power levels of the associated distribution legs and/or the signals carried therein are above a predefined threshold associated with undesirable ingress. This assessment may be carried out individually by the DIAs 50-54 and/or through some other off-site process, such as by the DIAs 50-54 outputting information to the controller for processing. System designers may experimentally or otherwise determine output level thresholds for use in associating normal or desirable operation with the distribution legs 14-18. Each distribution leg 14-18 may be assigned or associated with a different threshold depending on the signals being monitored and/or the services associated therewith such that output levels above that corresponding output level threshold may be considered as an indication of ingress.

The controller 40 may communicate the desired thresholds to the DIAs 50-54 and/or the DIAs 50-54 may be otherwise programmed with the thresholds, such by an on-site programmer or the like. Optionally, the DIAs 50-54 may be configured to switch or change thresholds as a function of different operating parameters and/or to simultaneously monitor different thresholds, such as for use in monitoring different frequency thresholds.

Output level increases may occur for any number of reasons, including when network devices 22-32 attempt to combat interferences and other ingress related problems. By raising or otherwise increasing their output levels, the network device 22-32 may be able to improve carrier-to-noise (C/N), signal-to-noise (S/N), and other interference related ratios or other operating parameters associated with improving signal communications. This may be done automatically by the network devices 22-32 adjusting output levels and/or as a function of instructions provided thereto. For example, if the controller 40 is associated with a cable modem termination system (CMTS) or other element associated with receiving signals from the network devices 22-32, the CMTS may be configured to assess signal noise and to instruct the network devices 22-32 associated therewith to combat the noise with increased output levels.

If one or more network devices 22-32 increase output levels above the associated threshold, the DIAs 50-54 may determine the output levels to be indicative of ingress. If the thresholds are not exceeded, Block 62 is returned to and the DIAs 50-54 continue to monitor output levels. If a threshold is exceeded, Block 66 is reached and attenuation is induced or otherwise imparted to the signals, a specific number of the signals, a frequency range of signals, across all signals carried in the distribution legs 14-18, and/or in some other manner in order to dampen or otherwise attempt to limit their ingress influence on other signals traveling over a shared communication medium, i.e., the common distribution leg 12.

Block 66 relates to inducing attenuation, such as but not limited to flat loss, to the signals on the distribution legs 14-18 having output levels above the desired threshold. The attenuation may be inserted by the DIAs 50-54 servicing the associated distribution leg and generally corresponds with any operation associated with reducing the influence of ingress on further signal communications. Optionally, the attenuation may decrease signal output equally across the frequency of the distribution leg 14-18 such that all signals are influenced with a common output level loss.

The amount of induced attenuation may vary depending on the excessive output levels associated therewith. For example, the attenuation may vary depending on the severity of the output level exceeding the corresponding output level threshold such that more attenuation may be induced for larger excesses. Optionally, the attenuation may be selected to decrease noise by a value deemed sufficiently capable of reducing the ingress influence on other signal communications, such as but not limited to a 10-20 dB decrease.

Block 68 relates to generating an alarm, message, or other warning if attenuation is induced. The alarm may include identifiers to identify the distribution leg 14-18 and/or network device 22-32 associated therewith and it may be communicated to the controller 40 or other entity for use in troubleshooting. Optionally, the alarm, and information associated therewith, may be correlated with other system operating characteristics, parameters, and data, including the instructions communicated to the network devices 22-32 to increase output levels, to facilitate identifying the source of ingress, which may include simply identifying the distribution leg 14-18 and/or a more granular determination, such as specifically identifying the network device 22-32.

As demonstrated above, one non-limiting aspect of the present invention relates to a DIA capable of monitoring aggregate upstream power level within an upstream spectrum on any distribution leg. Should the aggregate power level within the upstream spectrum on the leg being monitored reach or exceed a predetermined threshold, the DIA may compensate for the increase. While, multiple DIAs are shown, the system may include more or less DIAs, and the same and/or different locations, such as at each of the network devices so as to facilitate identifying specific network devices producing ingress and to limit the influence of the same.

Optionally, and without intending to limit the scope and contemplation of the present invention, when an aggregate power is above a threshold, such as but not limited to when the power indicates a noise floor and the existence of ingress additions of the type sufficient to create marginal conditions for the upstream path, the DIA may automatically inserts flat loss (attenuation) within the return path. The attenuation may be great enough to trigger a command from the CMTS to the modems to increase their transmit power to a level above the normal range of modem output operation but not enough to completely interrupt service to the distribution leg being monitored.

This increase in modem transmit power may then trigger an alarm via monitoring equipment normally used within the system so that system personnel may have the opportunity to address the ingress problem, without the customer completely losing service. If the aggregate noise/ingress level is sufficient to create severe upstream issues for the entire serving area of which the leg is a part, the DIA may increase the flat loss (attenuation) inserted to a point that is considered inadequate for upstream communications so that a more critical alarm can be generated on the monitoring equipment. In this manner, one non-limiting aspect of the present invention is able to combat ingress issues from customer premises that could affect the services that are utilizing the return band. The DIAs can be distributed at key junctions within the network where noise funneling takes place so that it can be determined which distribution leg is creating the ingress.

The DIA may be essentially passive in nature and as simple as possible and designed to take advantage of the already existing technology in which network routers have ‘long line AGC’ level control over cable modem output levels. The modem output level may be monitored since overly high output levels are an indication that the modem is trying to overcome noise or ingress by raising its levels to improve the carrier-to-noise signal ratio at the home before entering the upstream network. The DIA, by monitoring the aggregate power within the entire spectrum, can be tuned to detect a total power level that indicates problems are very likely and then trigger the insertion of flat loss to insure the problem gains attention.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of limiting ingress in a networking system having a number of distributions legs used to support upstream communications for a number of network devices, the method comprising:
determining an output level for an upstream signal carried over a distribution leg; and
attenuating the upstream signal if the determined output level is greater than an output level threshold so as to limit ingress.

2. The method of claim 1 further comprising determining the output level of the upstream signal with a dynamic ingress arrester (DIA) connected thereto.

3. The method of claim 2 further comprising inducing the attenuation with the DIA.

4. The method of claim 1 further comprising funneling separate upstream signals received from a plurality of distribution legs into a common distribution leg so as to facilitate further upstream communications of the signals and inducing the attenuation at locations downstream of a funnel used to funnel the signals so as to limit ingress transmission to locations upstream of the funnel.

5. The method of claim 4 further comprising associating different output power level thresholds for two or more of the distribution legs and only inducing attenuation if the output level of the distribution leg is greater than the associated output level threshold.

6. The method of claim 1 further comprising instructing the network devices to increase output levels in response to determining noise in the upstream signal emanating therefrom and inducing the attenuation if the output level of the upstream signal is increased above the output level threshold.

7. The method of claim 5 further comprising instructing the network devices to increase the output level of the upstream signal with signals communicated from a cable modem termination system (CMTS).

8. The method of claim 1 further comprising generating one or more alarms in response to the output levels being greater than the output level threshold.

9. The method of claim 7 further comprising associating identifiers within the alarms so as to facilitate identifying the distribution legs having output levels above the output level threshold.

10. The method of claim 1 further comprising inducing attenuation in proportion to a difference of the output level relative to the output level threshold.

11. The method of claim 1 further comprising determining the output level for signals carried within a define frequency spectrum of the distribution legs and attenuating the signal as a function thereof.

12. The method of claim 1 further comprising determining the output level for specific signals carried within the distribution leg and attenuating the signal as function thereof.

13. The method of claim 1 further comprising attenuating all signals carried within the distribution leg.

14. The method of claim 1 further comprising attenuating a selected portion of the signals carried within the distribution leg.

15. A networking system comprising:
a number of network devices;
a number of distributions legs to support upstream communications for the network devices; and
a dynamic ingress arresters (DIAs) associated with one or more of the distribution legs, the DIAs configured for inducing attenuation to the upstream signals if output levels of the associated distribution leg are greater than an output level threshold.

16. The system of claim 15 further comprising a funnel configured to combine the separate upstream signals from the distribution legs into a common distribution leg so as to facilitate further upstream communications of the same, and wherein the DIAs are located downstream of the funnel so as to limit ingress transmission to locations upstream of the funnel.

17. The system of claim 15 further comprising a device configured for instructing the network devices to increase output levels in response to determining noise in the signals emanating therefrom, wherein the DIAs induce attenuation to the signals associated with the network device instructed to increase output levels if the corresponding output levels are greater than the output level threshold.

18. The system of claim 17 wherein the device is a cable modem termination system (CMTS).

19. The system of claim 15 wherein the DIAs are configured for generating an alarm if the output levels are greater than the output level threshold.

20. The system of claim 19 wherein the alarm includes identifiers so as to facilitate identifying the distribution legs having output levels above the output level threshold.

21. The system of claim 15 wherein the DIAs are configured for inducing attenuation in proportion to a difference of the output level relative to the output level threshold.

22. The system of claim 15 wherein different output power level thresholds are associated with two or more of the distribution legs and the DIAs associated therewith only induce attenuation if the output level of the distribution leg is greater than the associated output level threshold.

23. A dynamic ingress arrester (DIA) configured for:
determining output levels of signals carried over a distribution leg; and
inducing attenuation to the signals if the output level is greater than an output level threshold.

24. The DIA of claim 23 further configured for generating an alarm if output level is greater than the output level threshold.

25. The DIA of claim 24 further configured for including identifiers in the alarm so as to facilitate identifying the distribution leg having output levels above the output level threshold.

26. The DIA of claim 23 further configured for inducing attenuation in proportion to a difference of the output level relative to the output level threshold.

27. The DIA of claim 23 further configured for inducing attenuation to a specific portion of the distribution leg.

28. The DIA of claim 23 further configured for inducing attenuation to specific signals carried within the distribution leg.

29. A method of identifying sources of ingress in a networking system having a number of distributions legs used to support upstream communications for a number of network devices, the method comprising:
determining output levels for the upstream signals carried over the distribution legs; and
identifying ingress associated with one of the distribution legs as a function of whether the output level of the distribution legs exceed an output level threshold.

30. The method of claim 29 further comprising identifying the ingress with a dynamic ingress arrester (DIA).

31. The method of claim 29 further comprising associating different output level thresholds with different distribution legs and identifying ingress as a function of the different output level thresholds.

32. The method of claim 29 further comprising associating multiple output level thresholds to at least one of the distribution legs and identifying ingress as a function thereof.
